(19) United States
(12) Patent Application Publication
(10) Pub. No.: US 2025/0198694 A1
(43) Pub. Date: Jun. 19, 2025

(54) COMMUNICATION MODULE AS A SENSOR HUB FOR A DOMESTIC REFRIGERATOR, AND DOMESTIC REFRIGERATOR

(71) Applicant: BSH Hausgeräte GmbH, München (DE)

(72) Inventors: Martin SCHIMMELE, Unterschneidheim (DE); Bernd OSBAR, Aalen (DE); Armin WEBER, Lauchheim (DE)

(21) Appl. No.: 18/848,585

(22) PCT Filed: May 4, 2023
(86) PCT No.: PCT/EP2023/061822

§ 371 Date: Sep. 19, 2024

(30) Foreign Application Priority Data
Jun. 7, 2022 (DE) 10 2022 205 769.4

(51) Int. Cl. F25D 29/00; G06F 13/42

(52) U.S. Cl. CPC F25D 29/005; G06F 13/4282; F25D 2700/02

(57) ABSTRACT

A communication module for a domestic appliance is configured as a sensor hub. The sensor hub is designed to process digital signals and to generate a signal for a communication bus.

One aspect of the invention relates to a communication module for a household appliance. One aspect also relates to a household refrigeration appliance.

A household refrigeration appliance which has specific sensors is known from EP 3 008 403 B1.

An illumination of an interior of a household refrigeration appliance is known from U.S. Pat. No. 6,804,974 B1. This interior illumination can be set to different brightness levels as a function of the ambient brightness surrounding the household refrigeration appliance.

It is the object of the present invention to provide a communication module for a household appliance in which a communication with sensors inside the appliance is improved.

This object is achieved by a communication module and a household appliance according to the independent claims.

One aspect of the invention relates to an electronic communication module for a household appliance which is configured as a sensor hub. The communication module is, in particular, a sensor hub. The sensor hub is configured for processing digital signals and is also configured for generating a signal for a communication bus of the household appliance outside the module.

A sensor hub is, in particular, a micro-controller unit or a coprocessor, data from different sensors being able to be integrated and processed thereby.

The sensor hub receives data and then forwards the data, in particular, to all connected devices (hosts).

The communication inside the appliance is improved by a specific communication module of this kind. In particular, signals from sensors of the household appliance outside the module can now be processed by this single communication module and thus also provided to a bus system inside the appliance.

In particular, therefore, a bus communication with a main electronics unit of the household appliance can also be carried out with this sensor hub. This main electronics unit can have a CPM (control power module). The communication can then be carried out on the basis of a D-bus message.

In one exemplary embodiment, the sensor hub has at least one digital input for receiving digital signals. In particular, therefore, digital signals of a digital sensor outside the module can be received and processed, in order to forward the information in turn to the bus system inside the appliance.

In one exemplary embodiment, the sensor hub has at least one first digital input for receiving digital signals and has a second input for receiving digital signals which is separate therefrom. Thus the one module can communicate with a plurality of sensors outside the module, in particular also simultaneously.

In one exemplary embodiment, the at least one digital input is also configured as a digital output. As a result, a bi-directional communication is possible between the communication module and at least one sensor outside the module.

In one exemplary embodiment, the communication module has a bus interface for connecting the communication module to a communication bus. The communication bus, in particular, is a bus system which is outside the module and which is a constituent part of the household appliance, i.e. in particular a bus system inside the appliance. Particularly advantageously, therefore, external signals from sensors of the household appliance can be processed and forwarded in the appliance.

In one exemplary embodiment, the bus interface is a D-bus interface. Inter-process communication is advantageously made possible thereby.

In one exemplary embodiment, the communication module has a single printed circuit board on which the components of the communication module, in particular the digital inputs and/or outputs and the bus interface, are arranged. In particular, at least one computing unit, which is configured for processing the received signals and for generating a bus signal, is also arranged on the printed circuit board.

In one exemplary embodiment, the communication module has a bus system inside the module, in particular an I2C bus, by which signals can be internally exchanged in the communication module. An I2C bus is a synchronous serial two-wire bus which in each case uses a bi-directional data and clock line and is suitable for the communication between components over short distances.

In one exemplary embodiment, the communication module is configured for communication with digital sensors outside the module. These sensors are thus not a constituent part of the communication module.

In one exemplary embodiment, the sensor hub is configured for processing digital signals and is configured for generating at least one signal for a communication bus from the received digital signals. Received sensor signals can also be converted thereby into a bus signal.

In one exemplary embodiment, the communication module has at least two internal sensors, wherein one sensor detects a first environmental parameter of the communication module and a further sensor detects a second environmental parameter of the communication module which is different from the first environmental parameter.

In one exemplary embodiment, a sensor inside the module is a brightness sensor and/or a sensor inside the module is a moisture sensor and/or a sensor inside the module is a temperature sensor.

Such a communication module forms an expansion interface for different sensor units (for example proximity sensor, brightness sensor, moisture/temperature sensor) in household appliances. This enables the cable sections and cable branches to be reduced. In particular, in an arrangement of the communication module in a pivoting door or drawer door of the household appliance, it is possible to reduce the number of cables via a door hinge/telescopic rail to the bus communication route to a central control unit of the household appliance.

In particular, the open and/or closed state of the drawer can be easily identified thereby. The opening and/or closing as such can also be accurately identified.

The position of the door can be detected by a door position identification sensor. In the simplest variant, the door position identification sensor detects a closed or open position of the door but can also be suitable for detecting a specific door angular position, for example by a proximity sensor arranged on a door hinge or by a gyro sensor arranged in the door, or a door movement by means of an acceleration sensor. The door position identification sensor can accordingly be a magnetic sensor, in particular a Hall sensor or Reed sensor, which detects or does not detect a magnetic field of a magnet provided in the door and thus can determine the open or closed position of the door. The one or more door position identification sensors are preferably provided on an upper horizontal front strip or in a recess on one of the door flanks which face one another in multiple-door or double-wing-door appliances. A double-wing-door appliance is understood to mean an arrangement of two adjacently arranged pivoting doors which have opposing pivoting directions and together close the same receiving space, generally a refrigeration space, of a household appliance. With a sensor arrangement of the magnet and magnetic sensor on the side flanks of the two double-wing doors facing one another, a single door position identification sensor is sufficient for both double-wing doors. The door position identification sensor can be provided integrally on the printed circuit board of the communication module or externally via a signal line at the inputs of the communication module. With an integral arrangement of the door position identification sensor, the signal can be sent directly via a communication interface outside the module to the control unit of the household appliance. With an external arrangement of the door position identification sensor, the position of the door can be sent to the communication module via a communication line which is connected to one of the digital inputs of the communication module, and transmitted by the communication module via the communication interface or bus interface outside the module to the control unit of the household appliance. With multiple-door appliances, a plurality of door actuation detection units can be linked to the communication module and combined together. As a result, the door position identification sensor of the household appliance is incorporated in the communication module via an input on the communication module and, with a plurality of door position identification sensors, they can be combined together via the communication module, whereby it is possible to reduce cable sections and complex branchings in the cable tree.

In particular, to this end a trigger signal can be generated by a sensor, for example a magnetic sensor. The signal can be provided for a camera of the household refrigeration appliance which, in particular, also detects the drawer. At least one image or a video can be made when moving, for example when closing, the drawer. A cable for this sensor can be inserted on the sensor hub.

One aspect also relates to a household appliance, in particular a household refrigeration appliance, which has a communication module according to the above-mentioned aspect or an advantageous exemplary embodiment thereof.

In one embodiment, the communication module can comprise a display facility and/or control facility for implementing operating settings, such as for example temperature or humidity settings, or sleep mode and holiday mode, on the household appliance. Accordingly, in addition to the components of the sensor hub, such as inputs, bus interface, communication bus inside the module, computing unit or coaxial connection, the preferably single printed circuit board of the communication module also comprises components of the display facility and/or control facility, such as for example capacitive switches for the data input, display elements for the data output and a corresponding computing unit for processing data for the data output to the display elements or transmission via the communication module, in particular bus interface, to the control unit of the household appliance. For simple access for the user, the communication module can be provided either on the front face of the door or behind a front strip of the housing. This has the advantage that cable sections and complicated branchings in the cable tree are further reduced thereby.

The communication module can have a sensor housing and a printed circuit board. The printed circuit board, in particular, is a cohesive single printed circuit board on which at least two separate sensors are arranged, wherein one sensor detects a first environmental parameter and a further sensor detects a second environmental parameter which is different from the first environmental parameter. As a result, the communication module is configured in a multifunctional manner. The communication module can receive a plurality of sensors on a printed circuit board in a compact manner and thus many different types of environmental information can be detected. Moreover, the communication module can correspondingly have both integral sensors and a communication line on the printed circuit board as a detection unit for environmental parameters.

A sensor can be a brightness sensor. The ambient brightness or the ambient light can be detected thereby.

A sensor can be a moisture sensor. The ambient moisture can be detected thereby. A sensor can be a temperature sensor. The ambient temperature can be detected thereby.

A sensor can be a door position identification sensor. For example, an opening of a door can also be detected thereby. The door position identification sensor can be a magnetic sensor. In particular, the identification of positions of two adjacent doors, for example double-wing doors of a household refrigeration appliance, is also made possible, in particular when the door position identification sensor is positioned centrally between the two doors. The identification of the positions of drawer doors of a household refrigeration appliance is also made possible thereby.

The communication module has a communication interface, the detected information from at least two of the sensors being able to be transmitted thereby. Thus only one such interface is required in order to be able to transmit information from a plurality of sensors. In particular, the communication interface is formed by the communication module.

In particular, at least one receiver, in particular solder pad, is configured on the printed circuit board, to which selectively different sensor types of a sensor, which detect the same environmental parameter, can be selectively attached. This means that with one and the same printed circuit board it is possible to attach a first sensor type of a sensor or a second sensor type of a sensor to the receiver. The receiver, which can also be denoted as a receiving region, is thus compatible in a versatile manner for these different sensor types.

In particular, the communication module has a sensor housing and a brightness sensor. The brightness sensor detects the brightness of the ambient light of the household appliance. The brightness sensor is arranged in the sensor housing. The household appliance has a housing with a front strip. The communication module is arranged on the front strip on the rear face. As a result, this communication module is positioned in a space-saving manner and protected from mechanical or other influences. Moreover, it uses an installation space which is in any case preferably present in the household appliance, in order to be able to be installed therein. As a result, other regions of the household appliance do not have to be reduced or reconfigured.

The communication module is arranged with at least one snap connection on the front strip. Such a releasable connection, on the one hand, is mechanically stable and, on the other hand, can be very easily released and re-attached. This enables a reversible mounting and dismantling in a simple manner.

In particular, the above-mentioned front strip is an upper horizontal front strip, when viewed in the height direction of the household appliance.

In one exemplary embodiment, the sensor housing is configured in multiple parts and it has a sensor housing part on the front face and a sensor housing part on the rear face.

In one exemplary embodiment, the communication module has at least one optical imaging element, in particular a lens, by which the incident ambient light on the sensor housing is focused toward the brightness sensor. Due to such an exemplary embodiment of a communication module with a brightness sensor, the ambient light can be conducted more extensively and more accurately onto the brightness sensor in the interior of the sensor housing. As a result, the accuracy of the determination of the brightness of the ambient light can be improved, in particular made more specific. Since a lens focusing the light is explicitly used here, and thus a converging lens which is configured to be convex, in particular at least on one side, is used, the ambient light can be focused to the brightness sensor.

In one exemplary embodiment, the lens is a lens which is of convex shape at least on one side. The lens can be spherical or aspherical. A particularly high proportion of the incident ambient light can thus be deflected in a targeted and directed manner to the brightness sensor.

In one exemplary embodiment, the brightness sensor is arranged in a focal point of the lens. As a result, the ambient light which is incident in the sensor housing arrives in a particularly localized manner on the brightness sensor.

In one exemplary embodiment, the lens can be configured as a component which is separate from the sensor housing. The lens can then also be arranged directly on the sensor housing. In particular, to this end the sensor housing can have a hole in which or adjacent to which the lens is arranged.

In an advantageous exemplary embodiment, the lens is configured in one piece with the sensor housing. The number of components can be reduced thereby. A particularly positionally accurate arrangement of the lens relative to the sensor housing is made possible thereby. This position can also be permanently maintained. A one-piece design also permits a simple production process. For example, an injection-molded component can be produced here. It is also possible that this component is a 2K-component. Thus, for example, the sensor housing and the lens can be formed from different materials, in particular produced by injection-molding.

It is also possible that the sensor housing is transparent at least in some regions. This means that at least in some regions the sensor housing is permeable to light in the spectral range visible to humans. In particular, the sensor housing can be transparent at the point at which the lens is arranged.

In one exemplary embodiment, the lens is arranged so as to be exposed on the sensor housing with at least one outer face toward the environment. As a result, the incident light from the environment falls directly on the outer face of the lens. Other extensive light paths which the ambient light has to cover initially, in particular also in the sensor housing, in order to be able to reach this lens and to be focused therein, can be dispensed with as a result. This also enables a short path from the lens to the brightness sensor in the sensor housing. It is also possible to avoid thereby undesired light losses of the ambient light which is incident on the sensor housing.

In one exemplary embodiment, the communication module has a light guide which is different from a lens. The light incident in the sensor housing is conducted thereby as intended. In particular, the light can be conducted to the brightness sensor.

In one exemplary embodiment, the lens and the light guide are coupled together. In particular, the lens is arranged upstream of the light guide in the beam path of the incident ambient light. This enables the light, on the one hand, to be focused and, on the other hand, to reach the brightness sensor in a targeted manner through the light guide. The light losses in the sensor housing can also be further reduced thereby. A particularly high proportion of the incident ambient light is then conducted in a very directed and defined manner to the brightness sensor.

In one exemplary embodiment, the lens is configured as an end of the light guide. The lens is configured, in particular, in one piece with the light guide. Such an integrated design of the light guide with the lens in turn enables the number of components to be reduced and a particularly accurate deflection and guidance of the incident ambient light to the brightness sensor.

In particular, the lens is produced in one piece with the light guide. For example, this can be a one-piece plastics component.

In one exemplary embodiment, the ambient light detection unit has a printed circuit board. The brightness sensor is arranged on this printed circuit board. In one exemplary embodiment, it can be provided that a moisture sensor is also arranged on this printed circuit board. Thus the one printed circuit board can be used for receiving a plurality of different sensors.

A further aspect of the invention relates to a household appliance. The household appliance can be, in particular, a household refrigeration appliance. In this regard, the household refrigeration appliance can be provided for storing and conserving food as intended. The household refrigeration appliance can be, for example, a refrigerator or a freezer.

In one exemplary embodiment, the household appliance has a housing. At least one receiving space for food is configured in this housing. This receiving space can be a refrigerated compartment or freezer compartment. In one exemplary embodiment, the household appliance has at least one door by which the receiving space can be closed on the front face. The door can be movably arranged on the housing. A household appliance with a communication module and a brightness sensor provided therewith is particularly advantageous when this receiving space is to be illuminated by an illumination apparatus of the household appliance at least when the door is open. Since a household appliance can be installed in very different environmental conditions, a wide variety of different degrees of brightnesses can occur at the installation site. Thus, for example, in very dark rooms or in very dark environmental conditions this can lead to a user who is opening the door and looking into the receiving space being potentially dazzled when the interior illumination or receiving space illumination is too bright. On the other hand, in other environmental conditions the interior illumination can be too dark or insufficient, or sufficient contrast to the ambient brightness cannot be provided. The aforementioned invention is particularly advantageous in order to be able to satisfy all of these very different installation conditions and thus the very different ambient brightness conditions associated therewith, and in order to adjust the interior illumination in a needs-based manner and as a function thereof. This is because the particularly accurate determination of the ambient brightness is made possible thereby. In turn, the interior illumination of the household appliance can be set in a particularly needs-based manner as a function thereof. When opening the door or when the door is open and an interior illumination is activated, this receiving space can be illuminated in a particularly needs-based manner and as a function of this detected ambient brightness.

In one exemplary embodiment, the household appliance has a housing. In particular, the household appliance has a front strip. This front strip is arranged on the housing. In this regard, the front strip is arranged on the front face on the housing. In one exemplary embodiment, the communication module is arranged with the brightness sensor on the front strip on the rear face. It can be arranged with a releasable mechanical connection on the front strip on the rear face. For example, such a releasable mechanical connection can be at least one snap connection. A particularly advantageous assembly of this sensor housing is achieved thereby. On the one hand, a mechanically stable fastening is made possible and, on the other hand, a concealed design is made possible. Therefore, this sensor housing is not exposed toward the front. However, it is possible for the incident ambient light on the front strip on the front face to reach the brightness sensor.

The front strip can be a horizontally oriented or a vertically oriented front strip. The front strip can also be a cross member. The front strip can be configured in a bar-like manner.

In one exemplary embodiment, the front strip has a hole through which the brightness sensor detects the incident ambient light. The remainder of the communication module is then arranged to be covered and also protected by the front strip. However, sufficient incident ambient light can pass through this hole into the sensor housing or onto the lens.

In one exemplary embodiment, the household appliance has at least one door by which the hole is at least shaded in the closed state of the door, so that at any rate reduced ambient light reaches the hole. Thus in this exemplary embodiment when the door is closed, the detection of the ambient light and thus also the evaluation of the brightness of the ambient light is only possible in a limited or insufficient manner. This is the case, in particular, when the household appliance is an integrated appliance and a separate design panel is arranged on a front face of a door leaf of the door. Such a design panel can be, for example, a furniture front panel. When viewed in the height direction of the household appliance, the hole is arranged in the front face so as to overlap with the design panel. In the depth direction of the household appliance, at most a minimum spacing is formed between the hole and the design panel so that the hole is shaded by the design panel at least relative to ambient light. Specifically in integrated appliances or appliances which potentially do not provide full coverage of the hole in the front strip when the door is closed, but are arranged sufficiently close thereto that a shading of the ambient light occurs, this is still an advantageous assembly position. This is because the communication printed circuit board with the brightness sensor can be assembled in a space-saving manner and the ambient brightness can still be very accurately detected when the door is at least partially open and thus the hole in the front strip no longer shaded. Although in one exemplary embodiment the ambient brightness cannot be detected or insufficiently detected when the door is closed, due to the shading which has been at least formed, the aforementioned assembly position is advantageous. This is because, for example, it is possible to use a free space which is present in the housing above a receiving space and in which other electronic components are also arranged. This space is thus also occupied by the communication module with the brightness sensor. Thus the volume of the receiving space can be maintained and this region can also be used for the electronic components, in particular above the receiving space, in order to position the communication module therein with the brightness sensor. This has corresponding advantages relative to avoiding the reconfiguration of other regions of the household appliance, in particular the household refrigeration appliance. However, the design is such that when the door is open the ambient brightness can be very accurately detected. This is sufficient, in particular, in order to be able to carry out an adaptation of the interior illumination to the detected ambient brightness very rapidly and in a needs-based manner, without the occurrence of undesired dazzling or too little illumination of the interior, depending on the ambient brightness.

In one exemplary embodiment, the household appliance has two separate doors which are arranged adjacent to one another in the width direction of the household appliance and which in the closed state bear against the horizontally and/or vertically oriented front strip, wherein, in particular, the hole is configured, in particular centrally, between the two doors on the horizontally and/or vertically oriented front strip. This is advantageous in a household refrigeration appliance which has two doors on the front face as double-wing doors. In the closed state of the doors, these doors bear, in particular, against a horizontally and/or vertically oriented front strip. If, when viewed in the width direction, the hole is arranged centrally between the narrow sides of the two doors facing one another, the communication module with the brightness sensor can be used for the two doors. This is because the hole, which is covered only in some regions by the two doors in the closed state, is exposed when a door is opened or this covering is removed such that sufficient incident ambient light can pass through the exposed region of the hole to the brightness sensor. This is also the case when the second door is still closed and the further region of the hole is still covered by this second door. Thus the interior illumination for each receiving space can also be operated individually and independently of one another, in particular in each case simply depending on whether the associated door is opened or is to be opened or not. Such a hole and a brightness sensor is only required in order to control at least the two separate interior illuminations of the two separate receiving spaces as a function of the respective door actuation and the ambient light detection.

In one exemplary embodiment, the household appliance has a door position identification sensor. This is provided as intended to detect a door actuation, wherein the detection unit can be activated for detecting the ambient brightness as a function of such a door actuation. Thus in one exemplary embodiment, the detection unit is activated only when the door is actuated. Otherwise the detection unit is, in particular, deactivated. An energy efficient operation can be achieved thereby. It is possible to avoid thereby undesirable faulty detection which would occur when the door is closed and would lead to an inaccurate ambient brightness detection. Preferably a door actuation can also be detected very accurately by this door position identification sensor. It is also possible to identify very accurately thereby when the detection is to start and subsequently when an adaptation of the interior illumination of the household appliance is to be carried out.

In one exemplary embodiment, it is provided that the household appliance has a control unit. The components of the household appliance are controlled by this control unit. In particular, the signals of the detection unit can also be processed thereby.

In one exemplary embodiment, it is provided that the detection unit is activated, in particular controlled by the control unit, for detecting the ambient brightness only when additionally a predetermined time interval has elapsed after the door actuation has been identified. This time interval is a maximum of one second. In one exemplary embodiment, this also means that the detection unit starts to detect the ambient brightness as a function of a door actuation, in particular the door starting to open, only with this time delay relative to the door opening. Thus it is also possible to avoid that an ambient brightness is determined when the door is still slightly open, which then potentially leads to incorrect or inaccurate results. In particular, it is possible that the illumination apparatus can be adjusted very rapidly by the control unit. This means that when the door is already correspondingly opened, the adaptation scenario with which the interior illumination is adapted as a function of the detected ambient brightness also takes place very rapidly. The observing user can also identify thereby that the appliance reacts in a semi-intelligent manner to the ambient brightness and automatically adapts the interior illumination in a needs-based manner. This adaptation can still be partially observed by the user. Due to the aforementioned time window in which the detection is completed within one second after the start of the measuring process and then the adaptation of the interior illumination takes place immediately, for example, it is possible to avoid undesired dazzling of the observer of the interior since too much illumination of the receiving space is avoided from when the door starts to open.

In one possible embodiment, it is provided that the brightness sensor is activated as a function of an actuation of the door. To this end, a door position identification sensor can be provided. Thus in one exemplary embodiment this door actuation can also be automatically detected. A door actuation, for example, is the initiating of an opening process, starting from the closed state of the door. If, for example, the door is opened starting from the closed state, the detection of the ambient light and the evaluation of the brightness of the ambient light are started via a control unit. In one exemplary embodiment, it can be provided that a defined time delay is predetermined between the start of the door actuation and the start of the detection of the brightness of the ambient light.

This can be a maximum of one second. This means that the detection of the ambient light by the brightness sensor is started after the beginning of the door actuation and this elapse of the predetermined time delay. In one exemplary embodiment, the time period for this detection process can be predetermined. In one exemplary embodiment, this detection time period can last between 0.5 seconds and 1.5 seconds. After evaluating the information relative to the ambient light, the interior illumination is then individually activated by the control unit in order to generate a specific illumination scenario in the receiving space. Thus a user, who is looking into the receiving space when the door is open, is not dazzled or confronted with too little illumination or too much illumination. In particular, when opening the door the user also perceives this needs-based adaptation of the illumination scenario of the receiving space with the interior illumination. Preferably, therefore, this adaptation of the illumination of the receiving space is undertaken when the door is already partially open, so that the user quite consciously perceives this change in this illumination scenario. In this context, it is also possible that the interior illumination is illuminated with a predetermined base brightness and/or a predetermined base light color at the beginning of the door actuation. If the detection of the ambient light and the determination of the brightness of the ambient light is then completed, in one exemplary embodiment this base setting of the interior illumination is adapted immediately in a needs-based manner. For example, the brightness can be successively increased starting from a base value, for example 25 percent of the maximum brightness of the interior illumination, in particular within a predetermined time interval. This time interval can be, for example, between 0.5 and 1.5 seconds. For example, the brightness can be set to a value of between 50 percent and 100 percent of the maximum brightness of the interior illumination as a function of the detected brightness of the ambient light. In this regard, discretely predetermined percentage brightness settings can also be set as a function of the maximum brightness of this interior illumination.

Since specifically in integrated appliances in the closed state of the door with the design panel arranged on the front side, practically no incident ambient light, or only minimal incident ambient light, can pass through the slots between the furniture front panel on the door and adjoining furniture walls, specifically in integrated appliances the detection of the ambient brightness in the closed state of the door is not expediently possible in order to be able to define accurately the actual brightness in the environment. Specifically in such arrangements, therefore, it is particularly expedient that the ambient brightness starts to be measured only when the door is already slightly open. Specifically in such arrangements the aforementioned invention is particularly expedient.

The positions and orientations provided when the appliance is used as intended and positioned as intended are specified by the terms “top”, “bottom”, “front”, “rear”, “horizontal”, “vertical” “depth direction”, “width direction”, “height direction”.

Further features of the invention are found in the claims, the figure and the description of the figures. The features and combinations of features mentioned above in the description and the features and combinations of features mentioned below in the description of the figures and/or shown individually in the figures are not only able to be used in the respectively specified combination but also in other combinations or individually without departing from the scope of the invention. Thus embodiments which are not explicitly shown and described in the figures but which emerge from the described embodiments and can be generated by separate combinations of features are to be regarded as encompassed and disclosed by the invention. Embodiments and combinations of features which thus do not have all of the features of an originally formulated independent claim are also to be regarded as disclosed.

Exemplary embodiments of the invention are described in more detail hereinafter with reference to schematic drawings, in which:

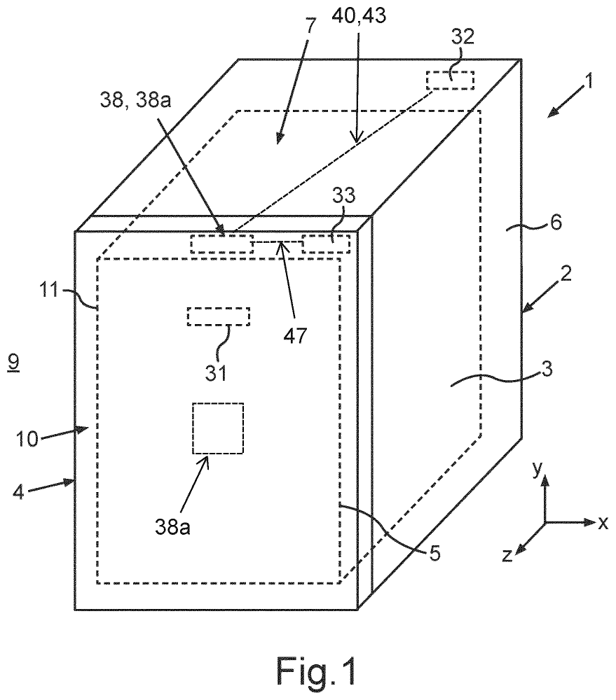

FIG. 1 shows a schematic perspective view of an exemplary embodiment of a household appliance according to the invention with an exemplary embodiment of a communication module according to the invention;

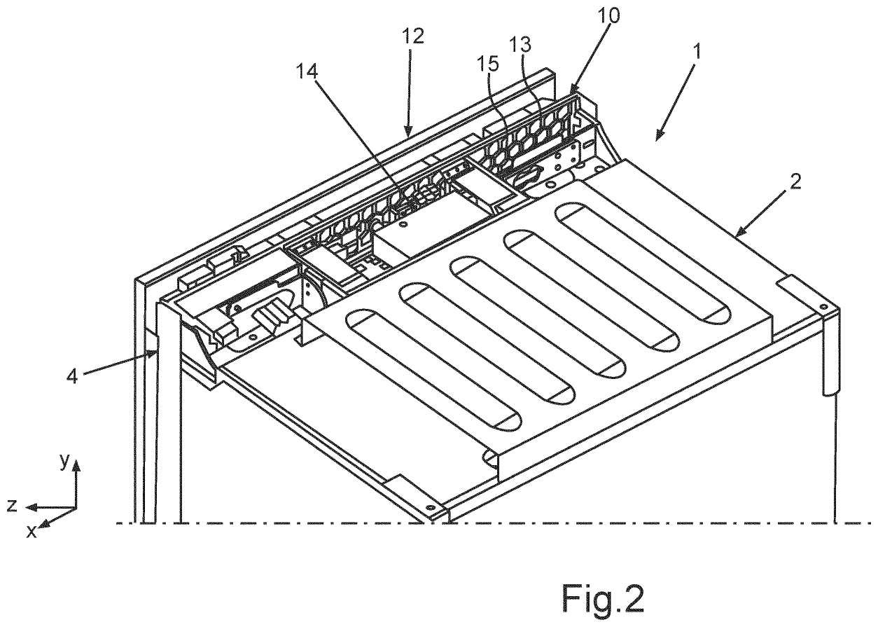

FIG. 2 shows a perspective view of the household appliance according to FIG. 1 in the upper region;

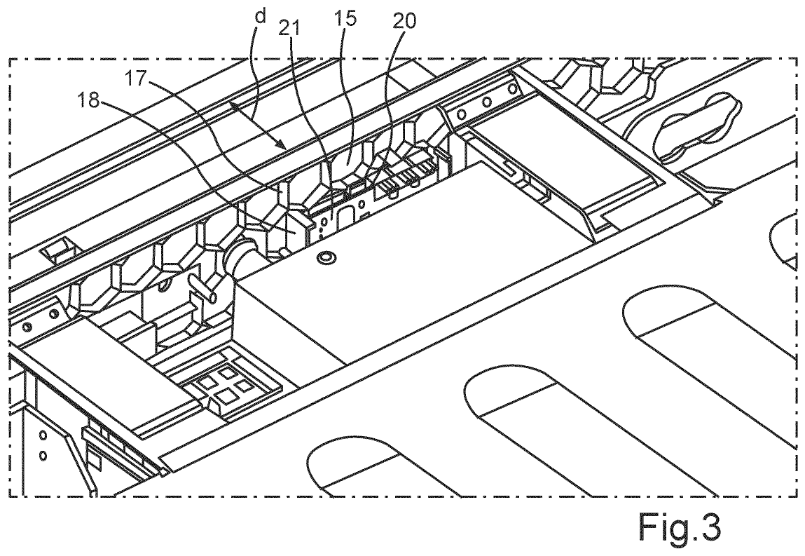

FIG. 3 shows an enlarged partial view of a detail in FIG. 2;

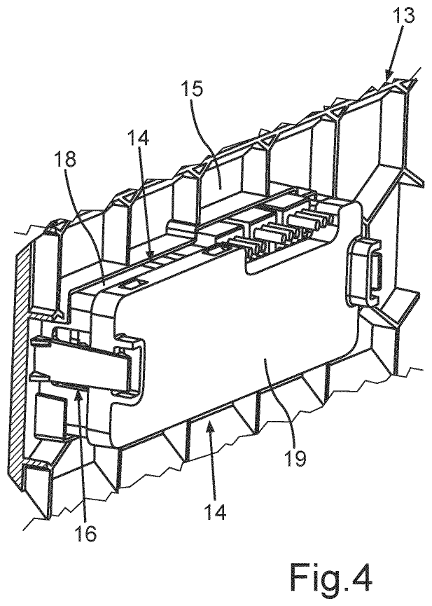

FIG. 4 shows a perspective sectional view of a front strip with a sensor housing of a communication module arranged thereon on the rear face;

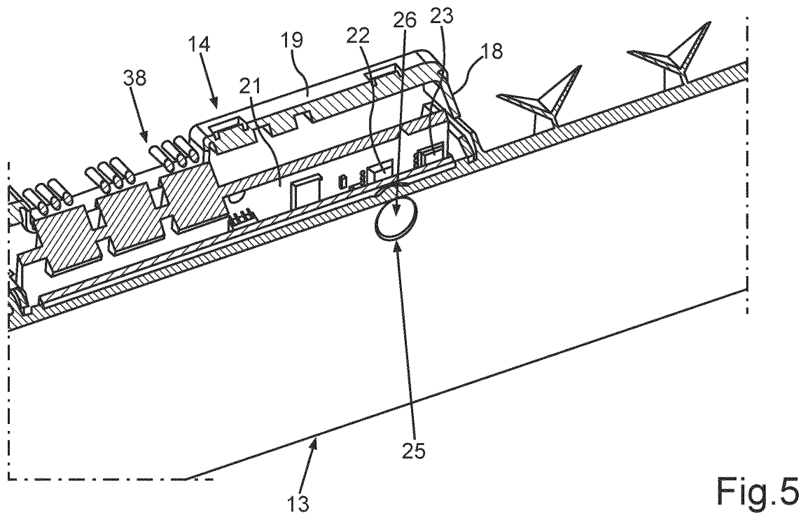

FIG. 5 shows a perspective sectional view through the arrangement according to FIG. 4;

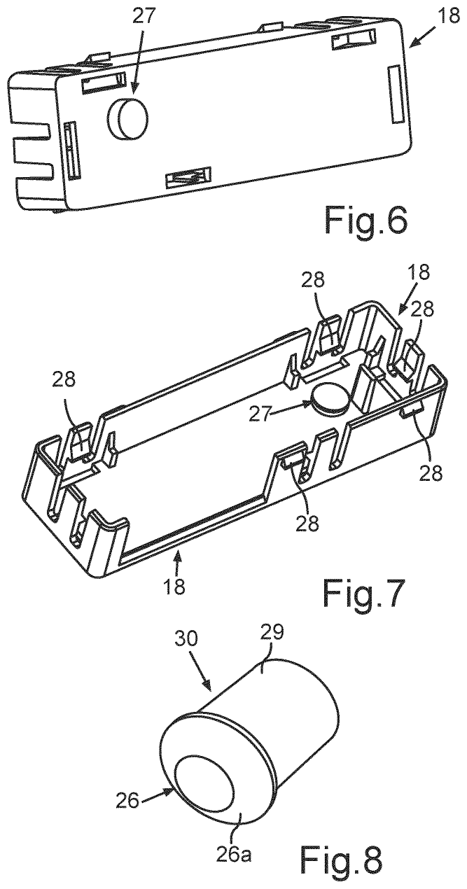

FIG. 6 shows a perspective view of an exemplary embodiment of a partial element of a sensor housing of a communication module;

FIG. 7 shows the sensor housing according to FIG. 6 in a different perspective from FIG. 6;

FIG. 8 shows an exemplary embodiment of an optical component of a communication module;

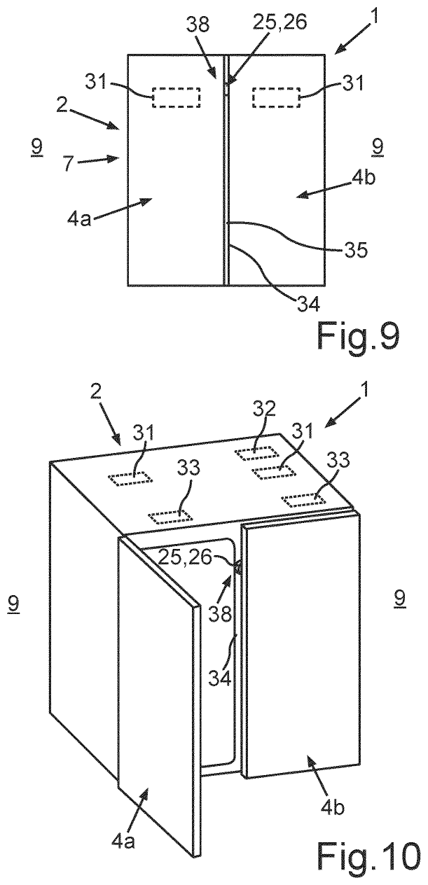

FIG. 9 shows a front view of a further exemplary embodiment of a household appliance;

FIG. 10 shows a perspective view of the exemplary embodiment according to

FIG. 9 with an open door;

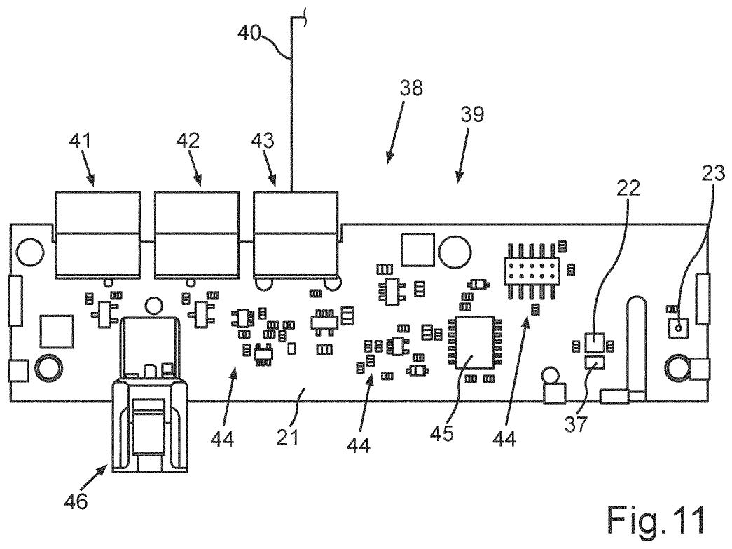

FIG. 11 shows a view of an exemplary embodiment of a communication module;

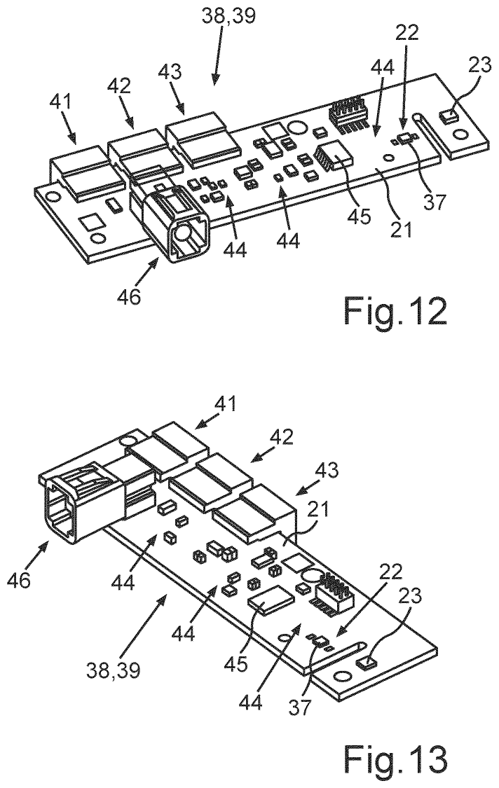

FIG. 12 shows the communication module according to FIG. 11 in a perspective view; and

FIG. 13 shows the communication module according to FIG. 11 in a different perspective view from FIG. 12.

Elements which are the same or functionally the same are provided with the same reference signs in the figures.

A household appliance 1 is shown in FIG. 1. In particular, the household appliance can be a household refrigeration appliance. This household refrigeration appliance can be configured for storing and conserving food. It can be a refrigerator or a freezer or a fridge-freezer. The household appliance 1 can, however, also be a dishwasher. A different household appliance is also possible. In particular, it is a household appliance which can be arranged as an integrated appliance in a furniture wall.

In the household appliance 1 provided herein it is provided in one exemplary embodiment that it is such an integrated appliance. The household appliance 1 has a housing 2. At least one receiving space 3 is configured in the housing 2. The receiving space 3 is provided here, in particular, for receiving food.

The household appliance 1 also has a door 4. The door 4 is movably arranged on the housing 2. The door is arranged for closing the interior or the receiving space 3 on the front face. The door 4 is shown here in the closed state. The receiving space 3 is defined by walls of a container 5. The container 5 can be, for example, an internal container which is configured from plastics. This is implemented, in particular, in such a manner in a household refrigeration appliance.

A free space can be configured between the container 5 and an outer housing 6. This free space can be filled at least in some regions with thermally insulating material. This is the case, for example, in a household refrigeration appliance. A free space 7 is formed in the height direction (y-direction) above the container 5 and the outer housing 6. This free space can also be denoted as an electronics assembly compartment. Electronics modules of the household appliance 1 can be installed in this electronics assembly compartment. In the exemplary embodiment, it is provided that a communication module 38 of the household appliance 1 is also arranged in this free space 7. The communication module 38 can have a display facility and/or control facility 38a with input and output means. The display and/or control facility 38a of the communication module 38 can alternatively be provided on a front face of the door 4 of the household appliance 1. The communication module 38 can have a brightness sensor 22 which is at least provided as intended to detect the brightness in an environment 9 of the household appliance 1. Thus the brightness of the ambient light of the household appliance 1 is detected by the communication module 8 with the brightness sensor 22.

The door 4 has a door leaf 10. This plate-shaped or cuboidal component also has an outer wall 11 and an inner wall or inner cladding which cannot be identified in FIG. 1. In particular, an intermediate space can be filled with thermally insulating material between the outer wall 11 and this inner cladding as is the case, for example, in a household refrigeration appliance. The position of the door 4 might be able to be detected by a door position identification sensor 33. The door position identification sensor 33 can be a proximity sensor, in particular a magnetic sensor, in particular a Hall sensor or Reed sensor, which detects a magnetic field of a magnet provided in the door 4 and can detect the open position or closed position of the door 4. The position of the door 4 is sent to the communication module 38 via a communication line 47 which is connected to one of the inputs 41, 42 (FIGS. 11-13) and transmitted to the control unit 32 by the communication module 38 via the communication interface 40 or bus interface 43 outside the module.

In particular when the household appliance 1 is an integrated appliance, in one exemplary embodiment a design panel 12 (FIG. 2) is also present. This design panel 12 which is separate from the door leaf 10 can, for example, be a furniture front panel. It covers the door leaf 10 from the front, in particular fully. The design panel 12, in particular, is fixedly connected to the door leaf 10 and, in particular, coupled in terms of movement thereto. In an integrated appliance, it is also provided that this household appliance 1 is arranged in an installation recess of a furniture wall. This installation recess is generally delimited by defining walls, in particular wall elements. Moreover, further regions of this furniture front wall can adjoin to the side in the width direction and upwardly in the height direction. In the closed state of the door 4 this results in quite a small gap between the outer edges of the furniture front panel 12 and the further furniture panels of this furniture wall adjoining thereto. Thus in this state and in such an exemplary embodiment it is the case that in practice ambient light from the environment 9 of the furniture wall cannot pass, or cannot pass to a sufficient degree, into the installation recess when the door 4 is closed. As a result, in this state and when the door 4 is closed, a sufficient detection of the ambient brightness is not possible.

In FIG. 2 an exemplary embodiment of the household appliance 1 is shown in a partial view and in perspective from above. As can be identified, the housing 2 has a front strip 13 in a front region, when viewed in the depth direction (z-direction). The front strip 13 extends in the width direction (x-direction) in a plate-like or strip-shaped manner. The front strip 13 is, in particular, a separate component. The front strip is arranged, in particular, on a front flange of the housing 2, in particular the outer housing 6. In the exemplary embodiment, it is an upper front strip 13. This means that the front strip is arranged on the upper front edge region of the housing 2, in particular the outer housing 6. In the exemplary embodiment shown, a sensor housing 14 of the communication module 38 is arranged on this front strip. In particular, this sensor housing 14 is arranged directly on a rear face 15 of this front strip 13. In one exemplary embodiment, a releasable mechanical connection could be implemented here. As can also be identified in FIG. 4, for example, a snap connection 16 is formed. The sensor housing 14 is snapped thereby on this rear face 15.

The front strip 13 is preferably configured from plastics. The front strip is produced, in particular, in one piece. For example, the front strip can be an injection-molded part. As can be identified in FIG. 2, and in FIG. 3 in an enlarged partial view of a detail of FIG. 2, in one exemplary embodiment the rear face 15 is formed with a reinforcing structure 17. This reinforcing structure can be, for example, a honeycomb structure.

In FIG. 3 the sensor housing 14 is shown in the enlarged view. A sensor housing 14 which is constructed from a plurality of sensor housing parts is implemented here. In FIG. 3 a front sensor housing part 18 is shown here. This front sensor housing part bears, in particular, directly against the rear face 15.

In one exemplary embodiment, the sensor housing 14 also has a further second sensor housing part 19. This is shown in FIG. 4. In one exemplary embodiment, the two sensor housing parts 18 and 19 are connected together by a releasable connection, for example by a snap connection. It is also possible that the snap connection 16 with which the sensor housing 14 is arranged on the rear face 15 is also at the same time the snap connection by which the two sensor housing parts 18 and 19 are held together.

An interior 20 is produced (FIG. 3) by the sensor housing parts 18 and 19. A printed circuit board 21 of the communication module 38 is arranged therein. In one exemplary embodiment, a brightness sensor 22 (FIG. 5) is arranged on this printed circuit board 21. In one exemplary embodiment, a moisture sensor 23 can also be arranged on the common printed circuit board 21.

As in FIG. 5, in which a perspective sectional view of the arrangement 24 in FIG. 4 can be identified, the front strip 13 has a continuous hole 25. Incident ambient light from the environment 9 can pass through this hole into the sensor housing 14, in particular through the front strip 13. It is provided, in particular, that the communication module 38 has at least one optical imaging element, in particular a lens 26. The lens 26 is a lens which focuses the incident ambient light. The lens can be configured to be curved in a convex manner on at least one optical upper face. In particular, the lens 26 is a converging lens. In one exemplary embodiment, the lens 26 is arranged exposed on the sensor housing 14 with at least one outer face 26a (FIG. 8) toward the environment 9.

In one exemplary embodiment, it is provided that the lens 26 is arranged such that incident ambient light is focused onto the brightness sensor 22. The lens 26 can be a component which is separate from the sensor housing 14, in particular from the front sensor housing part 18. It is also possible that the lens 26 is configured in one piece with the front sensor housing part 18.

In one exemplary embodiment, a perspective view of the front sensor housing part 18 is shown in FIG. 6. It can be identified here that an optical element 27 is configured so as to be integrated with this sensor housing part 18. Such a one-piece design can be produced, for example, from plastics. For example, this entire component can be configured as an injection-molded component. The optical element 27 can be the lens 26, for example. It is also possible that this optical part 27 is a cylindrical light guide. In a further exemplary embodiment, such a light guide can be an additional component of the communication module 38 with the brightness sensor 22. In particular, when the communication module 38 has both a lens 26 and a light guide, the lens 26 can be arranged in the beam path of the incident ambient light upstream of the light guide. Using a lens 26 and with a light guide, on the one hand, the focusing of the light beams can be implemented by means of the lens 26 and, on the other hand, the more targeted and directed forwarding of the light beams to the brightness sensor 22 can be implemented with the light guide.

In FIG. 7 the front sensor housing part 18 is shown in a different perspective from FIG. 6. In particular, the snap elements 28 which are provided in an example are shown, only some thereof being provided with a reference sign. A direct snap connection to the rear sensor housing part 19 and/or the front strip 13 can be implemented by means of these snap elements 28.

A light guide 29 is shown in one exemplary embodiment in FIG. 8. In addition, the lens 26 is shown here. In one exemplary embodiment, the lens 26, which is curved in a convex manner at least on the front face, can also be configured in one piece with the light guide 29, in particular produced in one piece. In one exemplary embodiment, the lens 26 is the front end of this entire part 30. The lens 26 can be arranged at least in some regions in the hole 25. It is also possible that the lens 26 is arranged offset to the rear relative to the hole 25.

The example shown in FIG. 8 of the one-piece entire part 30 can also be configured separately from the front sensor housing part 18 or in one piece therewith.

In one exemplary embodiment, the household appliance 1 has an interior illumination 31 as shown symbolically in FIG. 1. This interior illumination 31 is arranged for illuminating the at least one receiving space 3. In particular, this interior illumination 31 is activated when the door 4 is open.

A control unit 32 of the household appliance 1 is provided. Functional components of the household appliance 1 can be controlled by the control unit 32. In particular, the interior illumination 31 can also be controlled by the control unit 32. In particular, this takes place as a function of the ambient brightness detected by the brightness sensor 22. Thus the illumination of the interior 3 can be implemented by this interior illumination 31 in a particularly needs-based manner and adapted to the ambient brightness of the environment 9.

In particular, it is provided that the activation of the brightness sensor 22 takes place as a function of an actuation of the door 4. To this end, a door position identification sensor 33 can be provided. Thus in one exemplary embodiment this door actuation can also be automatically detected. A door actuation, for example, is the start of an opening process, starting from the closed state of the door 4. If for example the door 4 is opened, starting from the closed state, the detection of the ambient light and the evaluation of the brightness of the ambient light is started via the control unit 32. In one exemplary embodiment, it can be provided that a defined time delay is predetermined between the beginning of the door actuation and the start of the detection of the brightness of the ambient light. This can be a maximum of one second, for example. This means that after the beginning of the door actuation and this elapse of the predetermined time delay, the detection of the ambient light is then started by the brightness sensor 22. In one exemplary embodiment, the time period for this detection process can be predetermined. In one exemplary embodiment, this detection time period can last between 0.5 seconds and 1.5 seconds. After evaluating the information relative to the ambient light, the interior illumination 31 is then individually activated by the control unit 32 in order to generate a specific illumination scenario in the receiving space 3. Thus a user who is looking into the receiving space 3 when the door 4 is open is not dazzled or confronted with too little illumination or too much illumination. In particular, when opening the door 4 the user also perceives this needs-based adaptation of the illumination scenario of the receiving space 3 by the interior illumination 31. Preferably, this adaptation of the illumination of the receiving space 3 is undertaken when the door 4 is already partially open, so that the user quite consciously perceives this change in the illumination scenario. In this context, it is also possible that the interior illumination 31 is illuminated by a predetermined base brightness and/or a predetermined base light color at the beginning of the door actuation. If the detection of the ambient light and the determination of the brightness of the ambient light is completed, in one exemplary embodiment this base setting of the interior illumination 31 is immediately adapted in a needs-based manner. For example, the brightness can then be successively increased, starting from a base value, for example 25 percent of the maximum brightness of the interior illumination 31, in particular within a predetermined time interval. This time interval can be between, for example, 0.5 and 1.5 seconds. For example, the brightness can be set to a value of between 50 percent and 100 percent of the maximum brightness of the interior illumination 31 as a function of the detected brightness of the ambient light. In this regard, discretely predetermined percentage brightness settings can then be set as a function of the maximum brightness of this interior illumination 31.

A further exemplary embodiment of a household appliance 1 is shown in FIG. 9. In this case the household appliance is a household refrigeration appliance. The household appliance is shown in a front view. The household appliance 1 has two separate doors 4a and 4b. These doors are front doors. The doors can also be denoted as double-wing doors. The doors are arranged adjacent to one another in the width direction (x-direction) in the closed state shown. The doors are arranged at the same height position and at the same depth position. In one exemplary embodiment, in each case the doors 4a and 4b close a receiving space or interior for food. The receiving spaces are separate from one another. In particular, the household appliance 1 has two separate interior illuminations 31. Each one is provided for the illumination of one of the receiving spaces. The illumination of the receiving spaces by the assigned interior illuminations 31 can take place independently of one another. In particular, the activation of an 27 interior illumination takes place according to the descriptions which have been set forth above for the other exemplary embodiments.

In the closed state of the doors 4a and 4b, a gap 35 can be formed between the narrow sides of the doors 4a and 4b facing one another. A vertical front strip 34 can also be identified. In the closed state, the doors 4a and 4b bear against the front strip. The communication module 38 is arranged with the brightness sensor 22 on this vertically oriented front strip 34. In particular, the communication module 38 is arranged with the brightness sensor 22 on the rear face of the front strip 34. In one exemplary embodiment, the construction of the communication module 38 with the brightness sensor 22 can be as described in the previous exemplary embodiments. The vertical front strip 34 has a hole 25 through which incident ambient light can pass to the brightness sensor 22. As can be identified in FIG. 1, the hole 25 is preferably arranged centrally between the doors 4a and 4b, in particular centrally between the narrow sides of the doors 4a and 4b facing one another. Since the gap 35 is small in the state in which both doors 4a and 4b are closed, insufficient incident ambient light passes through the hole 25. Thus in the closed state of the doors 4a and 4b the ambient brightness cannot be detected. In particular, therefore, in the closed state of both doors 4a and 4b the ambient brightness detection unit 8 is at least deactivated, to the extent that the ambient brightness would be measured by the brightness sensor 22.

In the closed state of the doors 4a and 4b, the hole 25 is respectively covered thereby in some regions.

If a door 4a, 4b is opened, for example the door 4a as shown in FIG. 2, then the partial region of the hole 25 which was covered by this door 4a is exposed. Even if the other door, in this case the door 4b, remains closed, then the hole 25 is exposed to a such an extent that sufficient incident ambient light can pass through and an accurate detection of the ambient brightness by the brightness sensor 22 can take place. The interior illumination 31 is activated and operated as a function thereof, the interior illumination being intended to illuminate only the receiving space which can be closed on the front side by the open door, in this case the door 4a.

A plan view of an exemplary embodiment of a printed circuit board 21 is shown in FIG. 11. This single cohesive printed circuit board 21 is thus configured in one piece. This printed circuit board 21 is formed as a multi-sensor printed circuit board. This means that at least two different sensors are arranged on this printed circuit board 21. One sensor can detect a first environmental parameter and the second sensor can detect a second environmental parameter which is different from the first environmental parameter. A sensor can be a brightness sensor 22. A sensor can be a moisture sensor 23. A further sensor can be temperature sensor.

Generally an exemplary embodiment of a communication module 38 is also shown in FIG. 11. The electronic communication module 38 in this case is, in particular, a constituent part of the household refrigeration appliance 1. The electronic communication module is configured here as sensor hub 39. The communication module 38 has at least one computing unit 45. This computing unit is arranged on the common, in particular single, printed circuit board 21.

The sensor hub 39 is configured for processing digital signals and is configured for generating a signal for a communication bus 40. The communication bus 40 which is outside the module, but in particular inside the household appliance, is a D-bus system.

The sensor hub 39 has at least one digital input for receiving digital signals. In particular, the sensor hub 39 has at least one first digital input 41, in particular for receiving digital signals, and has a second input 42, in particular for receiving digital signals, which is separate therefrom.

In particular, the at least one digital input 41 and/or 42 is also configured as a digital output.

Preferably, the communication module 38 has a bus interface 43, in particular for connecting the communication module 38 to the communication bus 40.

The bus interface 43, in particular, is a D-bus interface.

In one exemplary embodiment, the communication module 38 has a bus system 44 inside the module, in particular an I2C bus, in particular by which signals can be internally exchanged in the communication module 38.

The communication module 38 is configured for communication with digital sensors which are outside the module but which are, in particular, a constituent part of the household refrigeration appliance 1.

The sensor hub 39 is configured, in particular, for processing digital signals and is configured for generating at least one signal for the communication bus 40 from the received digital signals.

In particular, the communication module 38 has at least two sensors 22, 23 inside the module, wherein one sensor 22 detects a first environmental parameter of the communication module 38 and a further sensor 23 detects a second environmental parameter of the communication module 38 which is different from the first environmental parameter.

Moreover, the communication module 38 has a coaxial connection 46. A connection for a coaxial cable is enabled thereby.

In particular, all of the aforementioned components of the communication module 38 are arranged on the printed circuit board 21.

The communication module 38 can also have a coaxial connection 46.

The communication module 38 according to FIG. 11 is shown in various perspectives in FIG. 12 and FIG. 13.

In one exemplary embodiment, the communication module 38 forms a communication interface 36 which is shown here by way of example. In particular, in one exemplary embodiment the communication interface 36 can be formed by the communication module 38.

Thus information can be transmitted from a plurality of different sensors via only one such specific communication interface 36. This information detected by the sensors can thus be transmitted by this communication interface 36 to a control unit, in particular the control unit 32. For example, an interior illumination 31 and/or a heating of the household appliance 1 can be directly controlled thereby.

In one exemplary embodiment, the printed circuit board 21 has receiving regions 37 (FIG. 11) which are configured for receiving different sensor types, wherein the different sensor types detect the same environmental parameter. A variability in the mounting of the different sensor types is provided thereby and the same printed circuit board 21 can always be used to this end. This means that the layout of the printed circuit board 21 is the same irrespective of the sensor type assembled thereon. In particular, the receivers are formed as specific solder pads. In addition to the exemplary embodiment with the multi-sensor arrangement, this exemplary embodiment can also be provided with different sensors which detect different physical environmental parameters.

### LIST OF REFERENCE SIGNS

1 Household appliance
2 Housing
3 Receiving space
4 Door
4a Door
4b Door
5 Container
6 Outer housing
7 Free space
9 Environment
10 Door leaf
11 Outer wall
12 Design panel
13 Front strip
14 Sensor housing
15 Rear face
16 Snap connection
17 Reinforcing structure
18 Sensor housing part
19 Sensor housing part
20 Interior
21 Printed circuit board
22 Brightness sensor
23 Moisture sensor
24 Arrangement
25 Hole
26 Lens
26a Outer face
27 Optical element
28 Snap element
29 Light guide
30 Entire part
31 Interior illumination
32 Control unit
33 Door position identification sensor
34 Front strip
35 Gap
36 Communication interface
37 Receiving region
38 Communication module
38a Display and/or control facility
39 Sensor hub
40 Communication bus outside the module
41 Input
42 Input
43 Bus interface
44 Communication bus inside the module
45 Computing unit
46 Coaxial connection
47 Communication line
x Width direction
y Height direction
z Depth direction
A Longitudinal axis

1-14. (canceled)

15. A communication module for a household appliance, the communication module being configured as a sensor hub that is configured for processing digital signals and for generating a signal for a communication bus.

16. The communication module according to claim 15, wherein said sensor hub has at least one digital input for receiving digital signals.

17. The communication module according to claim 16, wherein said sensor hub has at least one first digital input for receiving digital signals and a second input, separate from said at least one first digital input, for receiving digital signals.

18. The communication module according to claim 16, wherein said at least one digital input is also configured as a digital output.

19. The communication module according to claim 15, which comprises a bus interface for connecting the communication module to a communication bus outside said communication module.

20. The communication module according to claim 19, wherein said bus interface is a D-bus interface.

21. The communication module according to claim 15, which comprises a single printed circuit board on which components of the communication module are arranged.

22. The communication module according to claim 15, which comprises an internal bus system for signal exchange in the communication module.

23. The communication module according to claim 22, wherein said internal bus system is an I2C bus.

24. The communication module according to claim 15, wherein the communication module is configured for communication with external digital sensors.

25. The communication module according to claim 15, wherein said sensor hub is configured for processing the digital signals and configured for generating at least one signal for a communication bus from the received digital signals.

26. The communication module according to claim 15, wherein the communication module has at least two internal sensors, including a first sensor for detecting a first environmental parameter of the communication module and a second sensor for detecting a second environmental parameter of the communication module which is different from the first environmental parameter.

27. The communication module according to claim 26, wherein at least one of said sensors is a sensor selected from the group consisting of a brightness sensor, a moisture sensor, and a temperature sensor.

28. The communication module according to claim 15, which comprises at least one computing unit.

29. A household appliance, comprising at least one communication module according to claim 15.

30. The household appliance being a household refrigeration appliance.
